(19) United States
(12) Patent Application Publication
(10) Pub. No.: US 2014/0084895 A1
(43) Pub. Date: Mar. 27, 2014

(54) METHOD FOR PERFORMING REFRESHING CONTROL OF A DC-TO-DC CONVERTER, AND ASSOCIATED APPARATUS

(71) Applicant: ENERGY PASS INCORPORATION, Hsinchu City (TW)

(72) Inventors: Ming-Wei Lin, Hsinchu City (TW); Chao-Hsuan Liu, New Taipei City (TW)

(73) Assignee: ENERGY PASS INCORPORATION, Hsinchu City (TW)

(21) Appl. No.: 13/626,891

(22) Filed: Sep. 26, 2012

(51) Int. Cl. G05F 3/08

(52) U.S. Cl. 323/311

(57) ABSTRACT

A method for performing refreshing control of a direct current (DC)-to-DC converter includes: monitoring at least one duration of a control signal of a switching unit of the DC-to-DC converter to determine a statistics result, the duration corresponding to a duty cycle of the control signal; and based upon the statistics result, performing refreshing control on a bootstrap capacitor within the DC-to-DC converter. In particular, the step of monitoring the duration of the control signal of the switching unit of the DC-to-DC converter to determine the statistics result further includes monitoring whether a length of the duration falls within a predetermined range, wherein the statistics result represents a number of times that the length of the duration falls within the predetermined range. For example, the statistics result represents the number of times that the length of the duration successively falls within the predetermined range. An associated apparatus is also provided.

### BACKGROUND OF THE INVENTION

1. Field of the Invention

The present invention relates to switching converters such as Buck (or step-down) converters, and more particularly, to a method for performing refreshing control of a DC-to-DC converter, and to an associated apparatus.

2. Description of the Prior Art

In a conventional switching converter such as a Buck (or step-down) converter, a Buck topology is typically utilized for converting an input voltage to a lower output voltage. For example, the conventional Buck converter may include a pair of switching transistors coupled in series, with a high side switch and a low side switch being coupled to the input voltage level and a ground voltage level, respectively, where the switches are controlled to alternatively conduct with complementary duty cycles to maintain a predetermined output voltage. An output filter is typically coupled to the interconnection between the pair of switching transistors to average the switched input voltage, in order to provide the output voltage.

According to the related art, the high side switch and the low side switch can be implemented with Metal Oxide Semiconductor Field Effect Transistors (MOSFETs) such as N-channel MOSFETs (NMOSFETs). However, some problems may occur. More specifically, a gate to source voltage of approximately ten volts is required to fully enhance the NMOSFET switches, and therefore, implementing some special circuitry may become a must, in order to generate the required gate voltage for the high side NMOSFET switch. For example, the special circuitry is complicated, and additional costs are introduced due to the special circuitry. In another example, there is a tradeoff between the performance of the high side NMOSFET switch and the additional costs mentioned above. A proposal for providing the high side NMOSFET switch with the necessary gate drive voltage is charging a bootstrap capacitor with the input voltage or a regulated version thereof (e.g. a regulated voltage generated by regulating the input voltage, using a regulator), where some side effects and the associated tradeoff may be introduced. It seems unlikely that a sufficient gate voltage level can be continuously maintained. In a situation where the bootstrap capacitor is charged through the low side NMOSFET switch, its charge time and the bootstrap voltage thereof may decrease to an unacceptable level by the concomitantly reduced duty cycle of the low side NMOSFET switch. Thus, a novel method is required for refreshing the charge in a bootstrap capacitor within a DC-to-DC converter.

### SUMMARY OF THE INVENTION

It is therefore an objective of the claimed invention to provide a method for performing refreshing control of a direct current (DC)-to-DC converter, and to provide an associated apparatus, in order to solve the above-mentioned problems.

It is another objective of the claimed invention to provide a method for performing refreshing control of a DC-to-DC converter, and to provide an associated apparatus, in order to properly refresh the charge in a bootstrap capacitor within the DC-to-DC converter.

An exemplary embodiment of a method for performing refreshing control of a DC-to-DC converter comprises the steps of: monitoring at least one duration of a control signal of a switching unit of the DC-to-DC converter to determine a statistics result, wherein the duration corresponds to a duty cycle of the control signal; and based upon the statistics result, performing refreshing control on a bootstrap capacitor within the DC-to-DC converter. In particular, the step of monitoring the duration of the control signal of the switching unit of the DC-to-DC converter to determine the statistics result further comprises monitoring whether a length of the duration falls within a predetermined range, wherein the statistics result represents a number of times that the length of the duration falls within the predetermined range. For example, the statistics result represents the number of times that the length of the duration successively falls within the predetermined range with respect to periods of the control signal.

An exemplary embodiment of an apparatus for performing refreshing control of a DC-to-DC converter is provided, wherein the apparatus comprises at least one portion of the DC-to-DC converter. The apparatus comprises a monitoring circuit and a control circuit. The monitoring circuit is arranged to monitor at least one duration of a control signal of a switching unit of the DC-to-DC converter to determine a statistics result, wherein the duration corresponds to a duty cycle of the control signal. In addition, based upon the statistics result, the control circuit performs refreshing control on a bootstrap capacitor within the DC-to-DC converter. In particular, the monitoring circuit monitors whether a length of the duration falls within a predetermined range, wherein the statistics result represents a number of times that the length of the duration falls within the predetermined range. For example, the statistics result represents the number of times that the length of the duration successively falls within the predetermined range with respect to periods of the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing refreshing control of a direct current (DC)-to-DC converter according to a first embodiment of the present invention.

FIG. 2 illustrates a flowchart of a method for performing refreshing control of a DC-to-DC converter according to an embodiment of the present invention.

FIG. 3 illustrates a first monitoring scheme involved with the method shown in FIG. 2 according to an embodiment of the present invention.

FIG. 4 illustrates a second monitoring scheme involved with the method shown in FIG. 2 according to another embodiment of the present invention.

### DETAILED DESCRIPTION

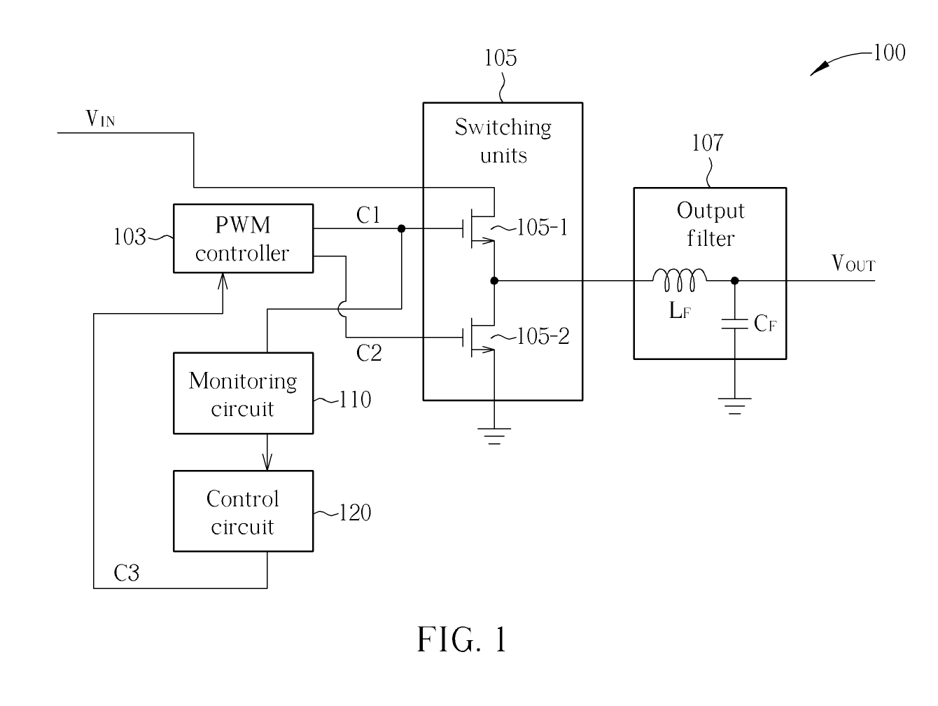

Please refer to FIG. 1, which illustrates an apparatus 100 for performing refreshing control of a direct current (DC)-to-DC converter according to a first embodiment of the present invention, where the DC-to-DC converter is utilized for converting an input voltage level V_{IN} into an output voltage level V_{OUT} thereof (more particularly, an output voltage level that is lower than the input voltage level). According to different embodiments, such as the first embodiment and some variations thereof, the apparatus 100 may comprise at least one portion (e.g. a portion or all) of the DC-to-DC converter. For example, the apparatus 100 may comprise a portion of the DC-to-DC converter. In another example, the apparatus 100 can be the whole of the DC-to-DC converter.

As shown in FIG. 1, the apparatus 100 comprises a pulse width modulation (PWM) controller 103, a plurality of switching units 105 such as a plurality of N-channel Metal Oxide Semiconductor Field Effect Transistors (N-channel MOSFETs, NMOSFETs), an output filter 107, a monitoring circuit 110, and a control circuit 120. More particularly, the switching units 105 of this embodiment may comprise a pair of switching units 105-1 and 105-2 (which can be MOSFETs such as NMOSFETs, for example) coupled in series, with the switching units 105-1 and 105-2 being coupled to the input voltage level V_{IN} and a ground voltage level, respectively. Please note that the switching units 105-1 and 105-2 can be regarded as a high side switch and a low side switch in this embodiment, respectively. In addition, the output filter 107 of this embodiment may comprise an inductor L_{F} and a capacitor C_{F}. This is for illustrative purposes only, and is not meant to be a limitation of the present invention. According to some variations of this embodiment, the output filter 107 may comprise at least one inductor (e.g. one or more inductors) and/or at least one capacitor (e.g. one or more capacitors) to form a low pass filter.

According to the first embodiment, the PWM controller 103 generates a plurality of control signals C1 and C2 (e.g. PWM control signals) for controlling the switching units 105-1 and 105-2, respectively. When the PWM controller 103 controls the control signal C1 to be at a high voltage level to turn on the switching unit 105-1, the PWM controller 103 controls the control signal C2 to be at a low voltage level. When the PWM controller 103 controls the control signal C2 to be at a high voltage level to turn on the switching unit 105-2, the PWM controller 103 controls the control signal C1 to be at a low voltage level. Thus, the switching units 105-1 and 105-2 are not turned on at the same time. In addition, the output filter 107 is coupled to a node between the pair of switching units 105-1 and 105-2 to average the switched input voltage, in order to provide the output voltage level V_{OUT}.

In this embodiment, a bootstrap capacitor (not shown) of the DC-to-DC converter mentioned above can be utilized for providing the aforementioned high voltage level of the control signal C1. The monitoring circuit 110 is arranged to monitor at least one of the control signals C1 and C2 (e.g. the control signal C1 and/or the control signal C2) to generate at least one statistics result and provide the control circuit 120 with the aforementioned at least one statistics result. An exemplary coupling relationship between the monitoring circuit 110 and the aforementioned of the control signals C1 and C2 (e.g. the control signal C1 and/or the control signal C2) is illustrated in FIG. 1, for better comprehension, where the monitoring circuit 110 can be arranged to monitor the control signal C1, for example. This is for illustrative purposes only, and is not meant to be a limitation of the present invention. According to a variation of this embodiment, the monitoring circuit 110 can be arranged to monitor the control signal C2. According to another variation of this embodiment, the monitoring circuit 110 can be arranged to monitor both of the control signals C1 and C2. No matter whether the monitoring circuit 110 is arranged to monitor the control signal C1 or the control signal C2 or both of the control signals C1 and C2, the control circuit 120 can perform refreshing control through a control signal C3 shown in FIG. 1.

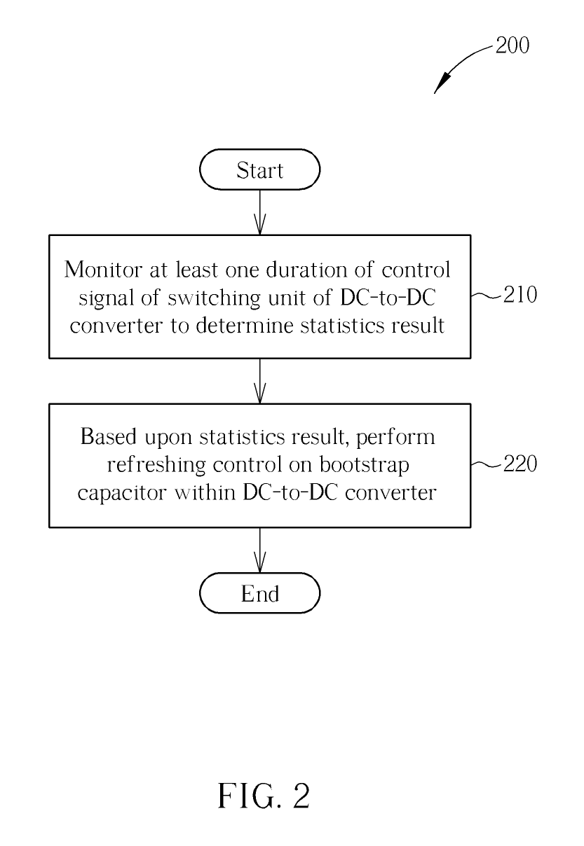

FIG. 2 illustrates a flowchart of a method 200 for performing refreshing control of a DC-to-DC converter according to an embodiment of the present invention. The method 200 shown in FIG. 2 can be applied to the apparatus 100 shown in FIG. 1. The method 200 is described as follows.

In Step 210, the monitoring circuit 110 monitors at least one duration (e.g. one or more durations) of a control signal of a switching unit of the DC-to-DC converter, such as the control signal C1 of the switching unit 150-1 or the control signal C2 of the switching unit 150-2, to determine a statistics result, where the duration corresponds to a duty cycle of the control signal under consideration (e.g. the control signal C1 or the control signal C2). For example, in a situation where the control signal C1 is monitored by the monitoring circuit 110, the duration corresponds to a duty cycle of the control signal C1. In another example, in a situation where the control signal C2 is monitored by the monitoring circuit 110, the duration corresponds to a duty cycle of the control signal C2.

More particularly, the monitoring circuit 110 monitors whether a length of the duration under consideration, such as at least one ON duration or at least one OFF duration, falls within a predetermined range, where the statistics result represents the number of times that the length of the duration under consideration falls within the predetermined range. For example, the predetermined range may represent a range of an interval whose values are less than a first predetermined threshold. That is, the monitoring circuit 110 monitors whether the length of the duration under consideration is less than the first predetermined threshold. In another example, the predetermined range may represent a range of an interval whose values are greater than or equal to a predetermined threshold such as the first predetermined threshold. That is, the monitoring circuit 110 monitors whether the length of the duration under consideration is greater than or equal to the aforementioned predetermined threshold such as the first predetermined threshold. Please note that the ON duration mentioned above represents a duration in which the control signal under consideration, such as the control signal C1 or the control signal C2, turns on the associated switching unit such as the switching unit 105-1 or the switching unit 105-2, respectively. In addition, the OFF duration mentioned above represents a duration in which the control signal under consideration, such as the control signal C1 or the control signal C2, turns off the associated switching unit such as the switching unit 105-1 or the switching unit 105-2, respectively.

In Step 220, based upon the statistics result, the control circuit 120 performs refreshing control on the aforementioned bootstrap capacitor within the DC-to-DC converter. More particularly, in a situation where, in Step 210, the monitoring circuit 110 monitors whether the length of the duration under consideration, such as the aforementioned at least one ON duration or the aforementioned at least one OFF duration, falls within the predetermined range to generate the statistics result, the control circuit 120 can perform refreshing control on the aforementioned bootstrap capacitor within the DC-to-DC converter according to the statistics result regarding the number of times that the length of the duration under consideration falls within the predetermined range.

Based upon the method 200 shown in FIG. 2, the apparatus 100 can properly determine (and accurately generate) the output voltage level V_{OUT} of the DC-to-DC converter according to the duty cycle of the control signal under consideration without introducing any of the side effects mentioned above.

Please note that, according to some embodiments, such as some variations of the embodiment shown in FIG. 2, operations disclosed in the descriptions of Step 210 and Step 220 can be repeated performed, respectively. In addition, according to some embodiments, such as some variations of the embodiment shown in FIG. 2, at least one portion (e.g. a portion or all) of operations disclosed in the descriptions of Step 210 and at least one portion (e.g. a portion or all) of operations disclosed in the descriptions of Step 220 can be performed at the same time.

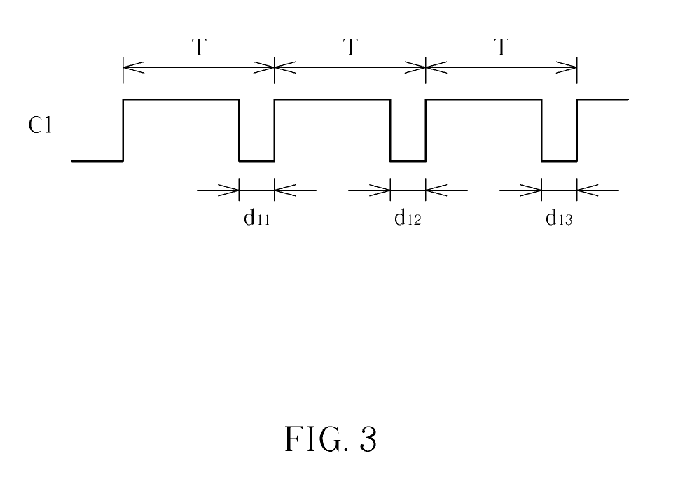

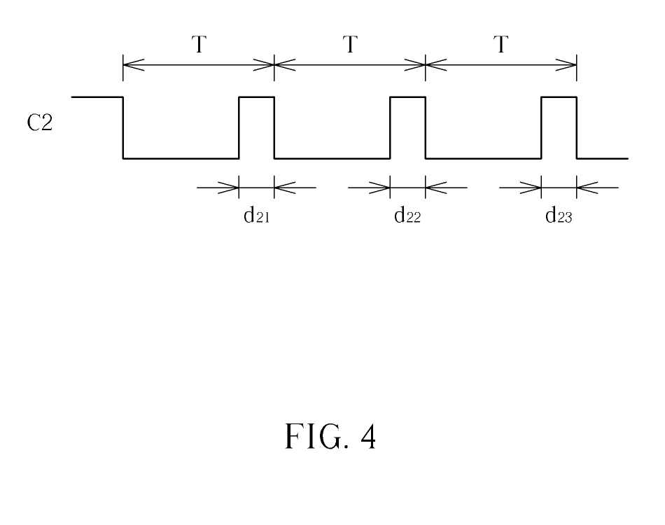

In some embodiments, such as some variations of the embodiment shown in FIG. 2 (e.g. the embodiments respectively shown in FIG. 3 and FIG. 4), the statistics result may represent the number of times that the length of the duration under consideration, such as the aforementioned at least one ON duration or the aforementioned at least one OFF duration, successively falls within the predetermined range with respect to periods of the control signal. More particularly, when the statistics result indicates that the number of times that the length of the duration under consideration successively falls within the predetermined range reaches a second predetermined threshold, the control circuit 120 triggers an operation of refreshing the bootstrap capacitor within the DC-to-DC converter. For example, the second predetermined threshold can be equivalent to three. In another example, the second predetermined threshold can be another positive integer that differs from three.

According to these embodiments, as a result of triggering the operation of refreshing the bootstrap capacitor, the charge of the bootstrap capacitor is refreshed. According to some of these embodiments, as a result of triggering the operation of refreshing the bootstrap capacitor, the length of the corresponding duration in the next period (e.g. the next ON duration that comes immediately after the aforementioned at least one ON duration, or the next OFF duration that comes immediately after the aforementioned at least one OFF duration) can be corrected to fall outside the predetermined range, where re-triggering the operation of refreshing the bootstrap capacitor can be temporarily prevented for a while.

Please refer to FIG. 3, which illustrates a first monitoring scheme involved with the method 200 shown in FIG. 2 according to an embodiment of the present invention, where the control signal C1 is taken as an example of the control signal under consideration, and the notation T represents the period of the control signal C1 in this embodiment. For better comprehension, suppose that the second predetermined threshold is equal to three.

According to this embodiment, when the statistics result indicates that each of the lengths d₁₁, d₁₂, and d₁₃ is less than the first predetermined threshold (and thus, the number of times that the length of the duration under consideration successively falls within the predetermined range reaches the second predetermined threshold), the control circuit 120 triggers the operation of refreshing the bootstrap capacitor within the DC-to-DC converter. As a result of triggering the operation of refreshing the bootstrap capacitor, the length of the corresponding OFF duration in the next period (i.e. the next OFF duration that comes immediately after the OFF duration having the length d₁₃) can be corrected to be equivalent to the first predetermined threshold, where re-triggering the operation of refreshing the bootstrap capacitor can be temporarily prevented for a while. Similar descriptions are not repeated for this embodiment.

Please refer to FIG. 4, which illustrates a second monitoring scheme involved with the method 200 shown in FIG. 2 according to another embodiment of the present invention, where the control signal C2 is taken as an example of the control signal under consideration, and the notation T represents the period of the control signal C2 in this embodiment. For better comprehension, suppose that the second predetermined threshold is equal to three.

According to this embodiment, when the statistics result indicates that each of the lengths d₂₁, d₂₂, and d₂₃ is less than the first predetermined threshold (and thus, the number of times that the length of the duration under consideration successively falls within the predetermined range reaches the second predetermined threshold), the control circuit 120 triggers the operation of refreshing the bootstrap capacitor within the DC-to-DC converter. As a result of triggering the operation of refreshing the bootstrap capacitor, the length of the corresponding ON duration in the next period (i.e. the next ON duration that comes immediately after the ON duration having the length d₂₃) can be corrected to be equivalent to the first predetermined threshold, where re-triggering the operation of refreshing the bootstrap capacitor can be temporarily prevented for a while. Similar descriptions are not repeated for this embodiment.

It is an advantage of the present invention that the present invention method and apparatus can properly determine the output voltage level of the DC-to-DC converter according to the duty cycle of the control signal under consideration without introducing any of the side effects mentioned above. As a result, the goal of accurately generating the output voltage level of the DC-to-DC converter can be achieved, where the related art problems will no longer be an issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing refreshing control of a direct current (DC)-to-DC converter, the method comprising the steps of:
monitoring at least one duration of a control signal of a switching unit of the DC-to-DC converter to determine a statistics result, wherein the duration corresponds to a duty cycle of the control signal; and
based upon the statistics result, performing refreshing control on a bootstrap capacitor within the DC-to-DC converter.

2. The method of claim 1, wherein the step of monitoring the duration of the control signal of the switching unit of the DC-to-DC converter to determine the statistics result further comprises:
monitoring whether a length of the duration falls within a predetermined range, wherein the statistics result represents a number of times that the length of the duration falls within the predetermined range.

3. The method of claim 2, wherein the predetermined range represents a range of an interval whose values are less than a first predetermined threshold.

4. The method of claim 2, wherein the statistics result represents the number of times that the length of the duration successively falls within the predetermined range with respect to periods of the control signal.

5. The method of claim 2, wherein the step of performing refreshing control on the bootstrap capacitor within the DC-to-DC converter further comprises:
when the statistics result indicates that the number of times that the length of the duration successively falls within the predetermined range reaches a second predetermined threshold, triggering an operation of refreshing the bootstrap capacitor within the DC-to-DC converter.

6. The method of claim 5, wherein the second predetermined threshold is equivalent to three.

7. The method of claim 1, wherein the switching unit is a Metal Oxide Semiconductor Field Effect Transistor (MOSFET).

8. The method of claim 7, wherein the MOSFET is an N-channel MOSFET (NMOSFET).

9. The method of claim 1, wherein the control signal is a pulse width modulation (PWM) control signal.

10. The method of claim 1, further comprising:
determining an output voltage level of the DC-to-DC converter according to the duty cycle of the control signal.

11. An apparatus for performing refreshing control of a direct current (DC)-to-DC converter, the apparatus comprising at least one portion of the DC-to-DC converter, the apparatus comprising:
a monitoring circuit arranged to monitor at least one duration of a control signal of a switching unit of the DC-to-DC converter to determine a statistics result, wherein the duration corresponds to a duty cycle of the control signal; and
a control circuit, wherein based upon the statistics result, the control circuit performs refreshing control on a bootstrap capacitor within the DC-to-DC converter.

12. The apparatus of claim 11, wherein the monitoring circuit monitors whether a length of the duration falls within a predetermined range; and the statistics result represents a number of times that the length of the duration falls within the predetermined range.

13. The apparatus of claim 12, wherein the predetermined range represents a range of an interval whose values are less than a first predetermined threshold.

14. The apparatus of claim 12, wherein the statistics result represents the number of times that the length of the duration successively falls within the predetermined range with respect to periods of the control signal.

15. The apparatus of claim 12, wherein when the statistics result indicates that the number of times that the length of the duration successively falls within the predetermined range reaches a second predetermined threshold, the control circuit triggers an operation of refreshing the bootstrap capacitor within the DC-to-DC converter.

16. The apparatus of claim 15, wherein the second predetermined threshold is equivalent to three.

17. The apparatus of claim 11, wherein the switching unit is a Metal Oxide Semiconductor Field Effect Transistor (MOSFET).

18. The apparatus of claim 17, wherein the MOSFET is an N-channel MOSFET (NMOSFET).

19. The apparatus of claim 11, wherein the control signal is a pulse width modulation (PWM) control signal.

20. The apparatus of claim 11, wherein the apparatus determines an output voltage level of the DC-to-DC converter according to the duty cycle of the control signal.
